(19) United States
(12) Patent Application Publication
(10) Pub. No.: US 2015/0375110 A1
(43) Pub. Date: Dec. 31, 2015

(54) SYSTEMS AND METHODS FOR SHOOTING IN ONLINE ACTION GAMES USING AUTOMATIC WEAPON AIMING

(71) Applicant: AlternativaPlatform Ltd., Valletta (MT)

(72) Inventor: Anton Alekseevich Volkov, Perm (RU)

(21) Appl. No.: 14/320,592

(22) Filed: Jun. 30, 2014

(51) Int. Cl. A63F 13/35; A63F 13/837

(52) U.S. Cl. CPC A63F 13/35; A63F 13/837

(57) ABSTRACT

Described is a gaming client computerized system for enabling an automatic aiming of a game weapon, the gaming client computerized system comprising a central processing unit, a network interface for connecting to a gaming server computerized system via a network; and a memory, the memory storing: a user interface module for receiving a weapon aiming information from a game player; a weapon aiming direction identification module for determining a plurality of aiming directions for the game weapon based on the received a weapon aiming information; a priority calculation module for calculating a priority value for each of the determined plurality of aiming directions for the game weapon based on location of one or more targets within the game; and a weapon aiming direction selection module for selecting one of the plurality of the determined aiming directions for the game weapon based on the calculated priority values.

### BACKGROUND OF THE INVENTION

1. Technical Field

The disclosed embodiments relate in general computer gaming technology and, more specifically, to systems and methods for shooting in online action games using automatic weapon aiming in the vertical plane.

2. Description of the Related Art

The mechanism for weapon aiming in computer action games, such as shooting games, is one of the most important factors determining the success of the game. The appearance of the video game, the difficulty of mastering it, and the intuitiveness of the game's user interface to the user are all determined, in a large part, by the weapon aiming mechanism utilized by the game. In the dawn of the game building era, it became evident that the user will always be limited by the gaming control devices available to him or her, because a whole world opens up to the user in which the user must interact with the surrounding virtual reality. The player is connected to this virtual world by virtue of a mouse and a keyboard and later by a gamepad or joystick. The simplest gaming task is to look around in the virtual world, and it turns into a test for those who are acquainting themselves for the first time with the world of games. It's important that the developer realizes that any complication on the level of simple gaming actions may lead to the player's simply giving up on the product, whether or not it is of interest to the user.

On the other hand, the most widespread weapon aiming mechanism in action computer games at the moment is the method of selecting the intended target using a mouse. Pursuant to such aiming method, it is assumed that the cursor's location on the screen is the point of focus of a character in the game and the point where the shots fired by the gaming character will land. When using such weapon aiming mechanism, the developer usually adds to the game a representation of an aiming crosshair, such that the user would be able to see the position of his or her aiming point at any given time. Choosing a target for a shot using such aiming mechanism is often complicated and is determined by the user's reaction time, because the user must look for the target in two dimensions simultaneously: vertically and horizontally. The target acquisition is further complicated by the fact that in order to reposition the game character and to choose an aiming target, there are often two different control devices used: the keyboard and the mouse. Thus, the user must become accustomed to moving the game character through the game's virtual world and changing the character's point of focus by means of two different actions performed by two different hands of the user using two different gaming control devices.

Accordingly, new and improved systems and methods are needed that simplify weapon aiming in computer action games, which improves the overall gaming experience of the user.

### SUMMARY OF THE INVENTION

The embodiments described herein are directed to methods and systems that substantially obviate one or more of the above and other problems associated with conventional systems and methods for weapons aiming in computer games.

In accordance with one aspect of the embodiments described herein, there is provided a gaming client computerized system for enabling an automatic aiming of a game weapon, the gaming client computerized system incorporating a central processing unit, a network interface and a memory, the memory storing: a user interface module for receiving a weapon aiming information in a horizontal plane from a game player; a weapon aiming direction identification module for determining a plurality of aiming directions for the game weapon in the vertical plane based on the received a weapon aiming information; a priority calculation module for calculating a priority value for each of the determined plurality of aiming directions for the game weapon based on location of one or more targets within the game; and a weapon aiming direction selection module for selecting one of the plurality of the determined aiming directions for the game weapon based on the calculated priority values.

In one or more embodiments, the determined plurality of aiming directions for the game weapon are weapon aiming directions in a vertical plane.

In one or more embodiments, the priority calculation module is configured to assign the priority value based on a distance to a target and wherein the priority value decreases with increase of the distance to the target.

In one or more embodiments, the priority calculation module is configured to assign the priority value based on a weapon aiming angle in the vertical plane and wherein the priority value decreases with increase of the weapon aiming angle in the vertical plane.

In one or more embodiments, the priority calculation module is configured to assign the priority value based on a game mode, wherein a target with a flag is assigned a higher priority value and wherein a friendly target is assigned a highest priority value.

In one or more embodiments, the system further comprises an additional priority calculation module for calculating an additional priority value for each of the determined plurality of aiming directions for the game weapon based on location of one or more targets within the game, wherein the weapon aiming direction selection module selects one of the plurality of the determined aiming directions for the game weapon based on both the calculated additional priority values and the calculated priority values.

In one or more embodiments, the memory further stores a transmission module for transmitting information on the selected one of the plurality of the determined aiming directions for the game weapon to a gaming server computerized system.

In one or more embodiments, gaming server computerized system validates a discharge of the game weapon.

In one or more embodiments, the gaming server computerized system transmits information on the selected one of the plurality of the determined aiming directions for the game weapon from the gaming server computerized system to other gaming client computerized systems.

In one or more embodiments, the gaming server computerized system transmits information on targets engaged by the game weapon to other gaming client computerized systems.

In one or more embodiments, the game weapon is a main gun of a battle tank.

In one or more embodiments, the weapon aiming direction identification module determines the plurality of aiming directions for the game weapon within a predetermined angular direction range corresponding to the game weapon between a minimal weapon aiming angle and a maximum weapon aiming angle.

In one or more embodiments, the priority calculation module is configured to assign the highest priority to an aiming direction of an un-obscured enemy target and the lowest priority to an aiming direction of a friendly target.

In one or more embodiments, the priority calculation module is configured to assign the highest priority to an aiming direction of at least two staggered enemy targets and the lowest priority to an aiming direction of a friendly target.

In one or more embodiments, the weapon aiming direction identification module determines the plurality of aiming directions for the game weapon based on deflection of a game weapon projectile by obstacles.

In one or more embodiments, the deflection of a game weapon projectile by obstacles is determined based on laws of physics.

In one or more embodiments, the game weapon comprises two barrels and wherein the weapon aiming direction identification module determines the plurality of aiming directions separately for each of the two barrels of the game weapon.

In one or more embodiments, the priority calculation module is configured to assign the highest priority to an aiming direction of a damaged friendly target and assign a lower priority to an aiming direction of an un-obscured enemy target.

In one or more embodiments, the weapon aiming direction identification module determines the plurality of aiming directions for the game weapon within a predetermined angular direction cone corresponding to the game weapon, wherein the aiming directions for the game weapon are limited in the horizontal and vertical plane.

In one or more embodiments, the priority calculation module is configured to assign a higher priority value to an aiming direction of an enemy target with a flag.

In accordance with another aspect of the embodiments described herein, there is provided a method for enabling an automatic aiming of a game weapon, the method being performed in connection with a gaming client computerized system comprising a central processing unit, a network interface and a memory, the method involving: receiving a weapon aiming information in a horizontal plane from a game player; determining a plurality of aiming directions for the game weapon in the vertical plane based on the received a weapon aiming information; calculating a priority value for each of the determined plurality of aiming directions for the game weapon based on location of one or more targets within the game; and selecting one of the plurality of the determined aiming directions for the game weapon based on the calculated priority values.

In accordance with yet another aspect of the embodiments described herein, there is provided a non-transitory computer-readable medium storing a set of instructions, which, when executed in connection with a gaming client computerized system comprising a central processing unit, a network interface and a memory, cause the computerized system to perform a method for enabling an automatic aiming of a game weapon, the method involving: receiving a weapon aiming information in a horizontal plane from a game player; determining a plurality of aiming directions for the game weapon in the vertical plane based on the received a weapon aiming information; calculating a priority value for each of the determined plurality of aiming directions for the game weapon based on location of one or more targets within the game; and selecting one of the plurality of the determined aiming directions for the game weapon based on the calculated priority values.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a client-server gaming system on which embodiments described herein may be deployed.

FIG. 2 illustrates an exemplary embodiment of an automatic game weapon aiming mechanism.

FIG. 3 illustrates operation of an exemplary embodiment of an automatic game weapon aiming mechanism.

FIG. 4 illustrates operation of another exemplary embodiment of an automatic game weapon aiming mechanism.

FIG. 5 illustrates operation of yet another exemplary embodiment of an automatic game weapon aiming mechanism.

FIG. 6 illustrates operation of yet another exemplary embodiment of an automatic game weapon aiming mechanism.

FIG. 7 illustrates operation of yet another exemplary embodiment of an automatic game weapon aiming mechanism.

FIG. 8 illustrates an exemplary embodiment of a computer platform whereupon the various embodiments described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the embodiments described herein, there are provided systems and methods for enabling weapon targeting in online action games using automatic weapon aiming in a vertical plane around a horizontal axis. In one or more embodiments, in order to simplify the user's aiming task and to enhance novice user experience from the game, the system enables the user to perform the target acquisition and weapon aiming in three dimensions using only the keyboard. As would be appreciated by persons of ordinary skill in the art, this enables less skilled users to successfully participate in the game and improves the intuitiveness of the user-game interaction.

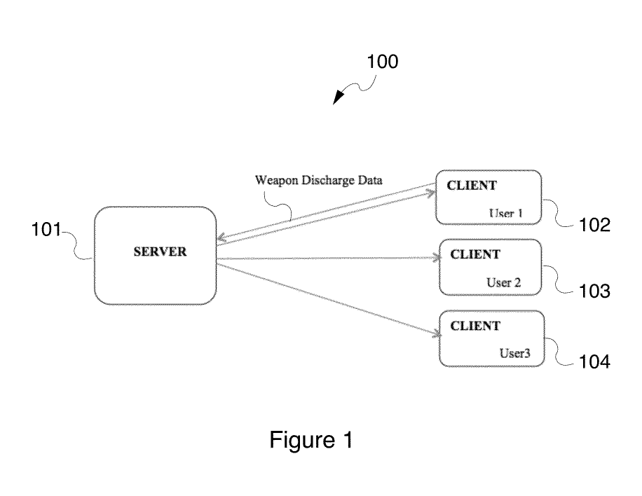

In the below description the term “client” or “gaming client” shall refer to the portion of the gaming software residing on the user's computer system, which is directly accessed by the user and enables the player's interaction with the game. On the other hand, the term “server” or “gaming server” shall refer to the portion of the gaming software deployed on the gaming server side, including, without limitation, the code for verifying the player data, as well as the code implementing a method for joining several game players in one gaming session. Exemplary embodiments of the aforesaid client-server gaming systems are illustrated in connection with FIG. 1, which depicts a distributed gaming system 100 incorporating a gaming server 101 and gaming clients 102, 103 and 104. The gaming server 101 is interconnected with the gaming clients 102, 103 and 104 via a network, such as to enable exchange of game-related data between them.

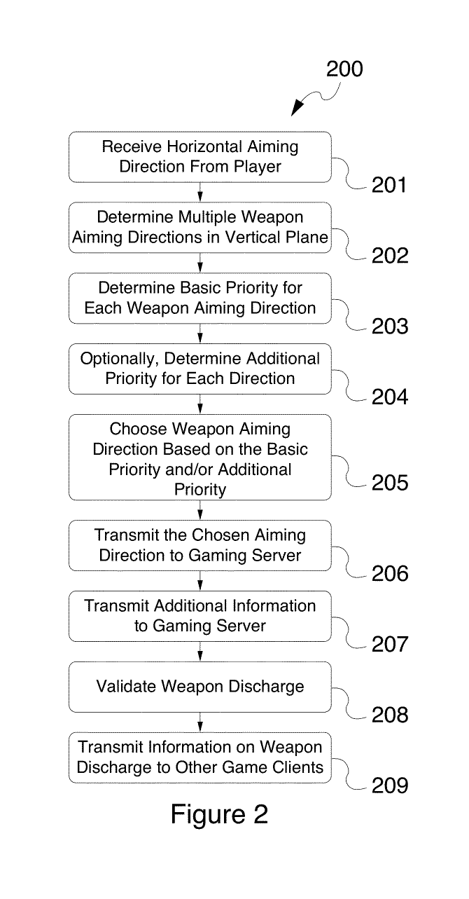

In one or more embodiments, in order to simplify a target acquisition by a novice player of an action game, such as a vehicle (tank)-related shooting game, an automatic weapon aiming mechanism in a vertical plane may be provided by the gaming software. An exemplary embodiment of such automatic weapon aiming mechanism 200 is illustrated in FIG. 2.

Pursuant to this automatic weapon aiming mechanism, the game player only needs to manually sight the intended target in the horizontal plane, see step 201, while the gaming software automatically aims the weapon in the vertical plane. In other words, the player manually fixes the horizontal direction of the weapon and initiates the weapon discharge, and the gaming system automatically handles the remaining actions (“automatic weapon aiming mechanism in the vertical plane”).

In one or more embodiments, for each weapon used in the game, the gaming system assigns and maintains the maximum downward pointing angle of the weapon and a maximum upward pointing angle of the weapon. In one or more embodiments, in order for the automatic weapon aiming mechanism in the vertical plane to work, the direction from the weapon to the target must be between the aforesaid maximum downward pointing angle and the maximum upward pointing angle of the weapon, with the aforesaid two angles defining the acceptable vertical angular range for the weapon.

In one or more embodiments, after the game player manually selects the weapon aiming direction in the horizontal plane, see step 201 in FIG. 2, and issues a weapon discharge command to the game client, the gaming client automatically verifies that the projectile exiting the weapon could be properly directed towards the intended target and seeks out multiple suitable weapon aiming directions in the vertical plane within the aforesaid acceptable vertical angular range for the weapon, see step 202. Out of these multiple directions in the vertical plane, the gaming client automatically chooses the highest-priority vertical direction for the weapon discharge based upon the location of the allies and/or enemies within the aforesaid acceptable vertical angular range for the specific weapon in accordance with the parameters, criteria and algorithms described herein. In one or more embodiments, the gaming client may automatically target the enemy that currently poses the highest threat to the game player. In another embodiment, the gaming client may automatically target the enemy that is closest to the game player.

In other words, the gaming client is configured to determine the priority for each aiming direction of the weapon in the vertical plane, see step 203 in FIG. 2, and to automatically choose one of the multiple weapon aiming directions in the vertical plane with the highest assigned priority as indicated in step 205. On the other hand, the priority assigned by the gaming client to specific vertical weapon aiming direction (basic priority) may depend on the game mode, the distance from the weapon to the target, and/or the aiming angle of the weapon in the vertical plane. In one or more embodiments, optionally, for separate types of weapons, an additional priority value may be also calculated at step 204, as described in detail below, which may also be used in choosing one of the multiple weapon aiming directions in the vertical plane.

In one or more embodiments, the farther out the target is, the lower the priority assigned to the corresponding aiming direction by the gaming client. Similarly, the greater the vertical weapon aiming angle is, the lower the priority assigned to the corresponding aiming direction by the gaming client. In one or more embodiments, if the enemy target has a flag, the priority of the aiming direction towards such target is increased by a predetermined amount. Finally, if the target is friendly, then the priority assigned to the respective vertical aiming direction is minimal.

In one or more embodiments, upon the receipt of the weapon discharge command from the user and after choosing the weapon aiming direction in the vertical plane as described above, the gaming client transmits to the gaming server the information on the chosen weapon aiming angle in the vertical plane, see step 206. In addition to this information, the gaming client transmits to the gaming server the data specifying the direction of the fired projectile as well as information on the targets, such as, for example, enemy tanks or other vehicles, that have been engaged (hit) by the projectile discharged from the weapon, see step 207. Upon the receipt of this information, the gaming server validates the weapon discharge event in accordance with a predetermined criterion or a set of criteria, see step 208, and, upon successful validation, transmits the received information on the automatically chosen weapon aiming angle in the vertical plane to other gaming clients participating in the gaming session, see step 209.

In one or more embodiments, further handling of the weapon discharge event by the gaming server, including automatic choosing of the weapon aiming direction in the vertical plane, is based on specific features of each weapon and/or groups of weapons. Several exemplary embodiments of gaming weapon types and the corresponding weapon discharge event handling algorithms will now be described in detail. As would be understood by persons of skill in the art, the described weapon types and the corresponding weapon discharge handling processes are exemplary only and any other type of weapon and the corresponding procedure or any combination thereof may be used in the action game.

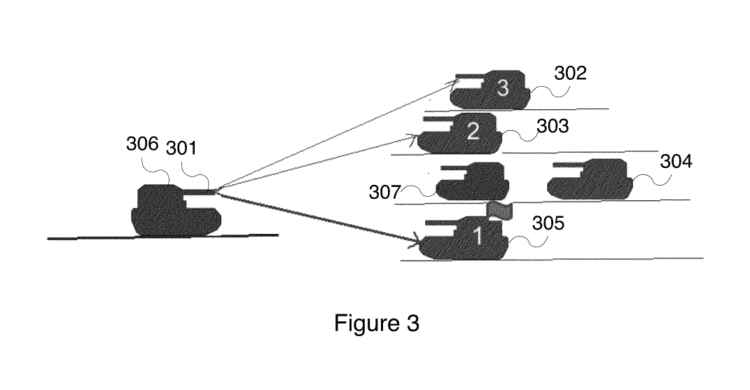

A first exemplary embodiment of a gaming weapon is called “smoky” and uses the basic algorithm, described in connection with FIG. 2 above (which is also utilized in the gaming weapon is called “thunder”), pursuant to which user first manually selects a weapon aiming direction in the horizontal plane and initiates a weapon discharge event, and the gaming client automatically selects the highest priority target positioned in the user-selected horizontal direction and within the acceptable vertical angular range for the weapon, which is not obscured by other targets. This exemplary embodiment of the gaming weapon is illustrated in FIG. 3, which shows gaming weapon 301 mounted on a vehicle, such as a tank, 306. In one or more embodiments, the priorities of the targets 302, 303, 304 and 305 are determined based upon the above-described priority assignment algorithm. As would be appreciated by persons of ordinary skill in the art, this technique guarantees accurate and effective engagement of the intended target by the game weapon 301, minimizes the probability of a miss and excludes the possibility of hitting a friendly target 307 in the battlefield. In one or more embodiments, the weapon 301 is the main gun of a tank 306, such as a main battle tank. In other embodiments, the weapon is a self-propelled gun, a howitzer, a mortar or any other type of battlefield artillery.

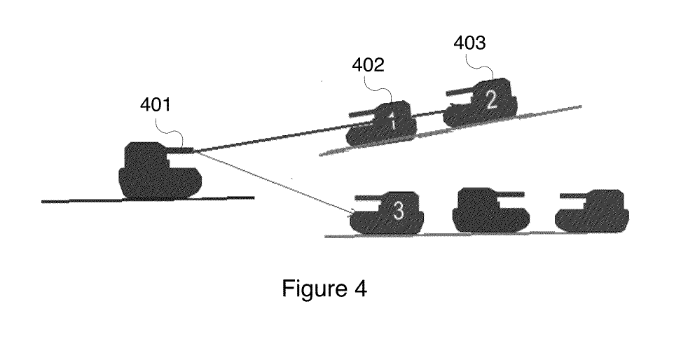

A second exemplary embodiment of a gaming weapon is called “railgun” and uses the aforesaid weapon discharge handling algorithm of the described smoky weapon with certain modifications described below. This exemplary embodiment of the gaming weapon is illustrated in FIG. 4. Specifically, an additional priority value attributed to the railgun weapon 401 arises from the railgun weapon's ability to inflict damage on several targets (402, 403) simultaneously, by using a projectile, which has the ability to penetrate (through) multiple targets (402, 403) with one shot. In one or more embodiments, the calculated additional priority value for the railgun weapon does not depend on the distance from the weapon to the target.

In one or more embodiments, the aforesaid additional priority value is determined separately for each weapon discharge for each weapon aiming direction. Subsequently, the weighted sum of these additional priorities is calculated, wherein the weight values used in calculating the sum are proportional to the damage that could be inflicted to each subsequent target. In one or more embodiments, the weight value for the first target is 1, for the second target is k, for the third target is k̂2 and so on, wherein k is the damage attenuation coefficient. As would be appreciated by persons of skill in the art, the calculated weighted sum represents a combined damage to multiple enemy targets on the line of fire of the railgun weapon, which all could be hit using one projectile. In one or more embodiments, the higher is the calculated combined damage to the multiple enemy targets, the higher is the priority of the corresponding weapon aiming direction.

In one or more embodiments, the gaming software is configured to choose the weapon aiming direction in the vertical plane from among the multiple candidate weapon aiming directions to maximize the aforesaid calculated additional priority value. If the calculated additional priority value is the same for two candidate directions, the direction with the higher basic priority is selected. In other words, for the railgun weapon, the gaming client would select an aiming direction in the vertical plane, such that the combined damage to multiple targets in the line of fire of the railgun weapon is maximized.

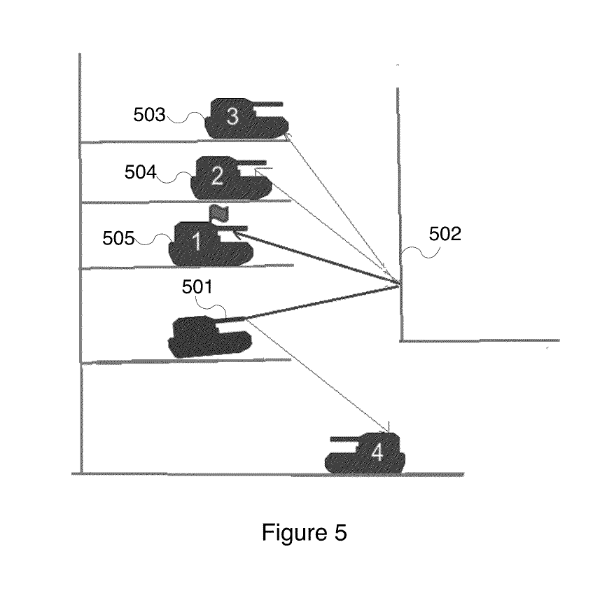

A third exemplary embodiment of a gaming weapon is called “ricochet” and is illustrated in FIG. 5. The projectile discharged by the ricochet weapon 501 is capable of bouncing off obstacles, such as building walls 502. In one or more embodiments, the trajectory of the bounced projectile is calculated using the general laws of physics, well known to persons of ordinary skill in the art. Specifically, these laws determine the deflection angle of the bounced projectile. In one or more embodiments, the gaming client selects the weapon aiming direction in the vertical plane taking into account all bounces of the projectile discharged from the weapon. To this end, the gaming client may simulate the bounces of the projectile and determine the total damage to the enemy targets 503, 504 and 505 from the bounced projectile. In one or more embodiments, this weapon uses the basic auto-aiming algorithm in the vertical plane, described in connection with FIG. 2 above.

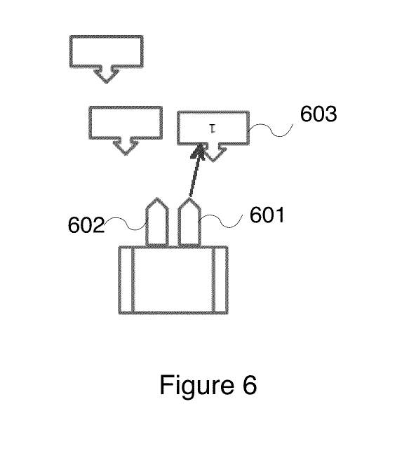

A fourth exemplary embodiment of a gaming weapon is called twins, which is a weapon having two barrels 601 and 602 illustrated in FIG. 6. The weapon fires pairs of projectiles, which are fired from each of the two barrels in an alternating manner. In one or more embodiments, this weapon uses the basic auto-aiming algorithm in the vertical plane, described in connection with FIG. 2 above. In one or more embodiments, the automatic aiming mechanism operates independently for each barrel. Thus, the priority aiming direction is chosen for each barrel, but upon the weapon discharge, only one aiming direction is chosen (the automatic aiming mechanism operates for the specific weapon barrel, which is used by the player to fire).

A fifth exemplary embodiment of a gaming weapon is called shaft, which is weapon with two firing modes. In the first sniper mode, the target is manually selected by the player and the automatic aiming is disabled. In the second automatic mode, the weapon is automatically aimed using the techniques described above in connection with the rail weapon.

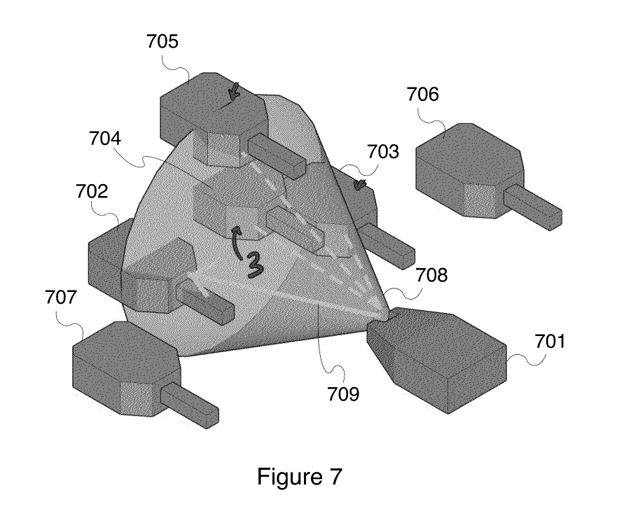

A sixth exemplary embodiment of a gaming weapon is called isida, which is a weapon with an alternative aiming mode, different from the basic auto-aiming algorithm in the vertical plane, described in connection with FIG. 2 above, operation of which is illustrated in FIG. 7. Specifically, for the isida weapon 701, the priority is determined in a descending order in the following manner: a damaged friendly target 702, enemy targets 703, 704 and 705, and an empty space. In team battles, the isida weapon discharge may repair damage to damaged friendly tanks 702 and, at the same time, damage the enemy targets 703, 704 and 705. Thus, within the bounds of the automatic aiming region, the gaming client will first seek out damaged friendly vehicles 702 and, with a lower priority, the enemy targets 703, 704 and 705.

As stated above in connection with the described gaming weapons, there is a predetermined maximum downward pointing angle of the weapon and a maximum upward pointing angle of the weapon. On the other hand, for the isida weapon, there is a cone 708 of suitable weapon aiming directions. In other words, there is a vertical and a horizontal range of acceptable isida weapon aiming angles. Enemy targets 706 and 707 located outside of the cone 708 are not automatically targeted. In one or more embodiments, the isida weapon is positioned parallel to the surface (ground). The player can change the position of the aforesaid cone of suitable weapon aiming directions by changing the position (and orientation) of the isida weapon, which could be accomplished by changing the position and orientation of the vehicle (tank) carrying the isida weapon. If the calculated additional priority value is the same for two candidate directions, the direction with the higher basic priority is selected.

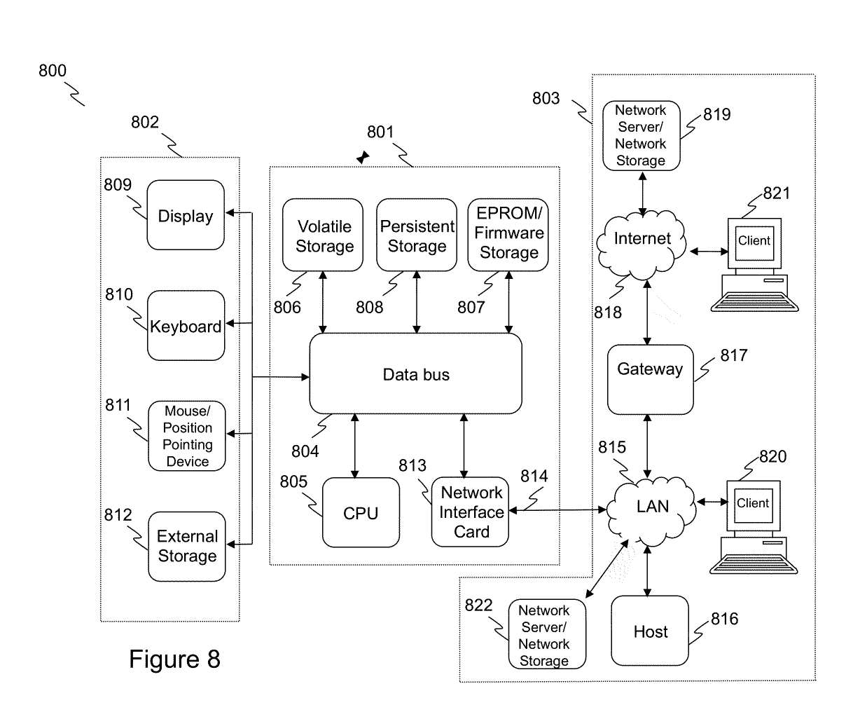

FIG. 8 is a block diagram that illustrates an embodiment of a computer system 800 upon which various embodiments of the inventive concepts described herein may be implemented. The system 800 includes a computer platform 801, peripheral devices 802 and network resources 803. In one or more embodiments, the computer platform 801 may be implemented within the form factor of a desktop computer or a server well known to persons of skill in the art. In an alternative embodiment, the computer platform 801 may be implemented based on a laptop computer, a notebook computer, a tablet computer, a smartphone or other mobile computing device.

The computer platform 801 may include a data bus 804 or other communication mechanism for communicating information across and among various parts of the computer platform 801, and a processor 805 coupled with bus 804 for processing information and performing other computational and control tasks. Computer platform 801 also includes a volatile storage 806, such as a random access memory (RAM) or other dynamic storage device, coupled to bus 804 for storing various information as well as instructions to be executed by processor 805, including the software application for proxy detection described above. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 804 for storing information and instructions.

Computer platform 801 may be coupled via bus 804 to a touch-sensitive display 809, such as a cathode ray tube (CRT), plasma display, or a liquid crystal display (LCD), for displaying information to a system administrator or user of the computer platform 801. An input device 810, including alphanumeric and other keys, is coupled to bus 804 for communicating information and command selections to processor 805. Another type of user input device is cursor control device 811, such as a mouse, a trackball, or cursor direction keys for communicating direction information and command selections to processor 805 and for controlling cursor movement on touch-sensitive display 809. This input device typically has two degrees of freedom in two axes, a first axis (e.g., x) and a second axis (e.g., y), that allows the device to specify positions in a plane. To detect user's gestures, the display 809 may incorporate a touchscreen interface configured to detect user's tactile events and send information on the detected events to the processor 805 via the bus 804.

An external storage device 812 may be coupled to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 808. Volatile media includes dynamic memory, such as volatile storage 806.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is coupled to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 814 typically provides data communication through one or more networks to other network resources. For example, network link 814 may provide a connection through local network 815 to a host computer 816, or a network storage/server 822. Additionally or alternatively, the network link 814 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 815 and communication interface 813. In the Internet example, when the system 801 acts as a network server, it might transmit a requested code or data for an application program running on client(s) 820 and/or 821 through the Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for enabling weapon targeting in online action games using automatic weapon aiming. It is intended that the specification and examples be considered as exemplary only, with a true scope and spirit of the invention being indicated by the following claims.

What is claimed is:

1. A gaming client computerized system for enabling an automatic aiming of a game weapon, the gaming client computerized system comprising a central processing unit, a network interface and a memory, the memory storing:
a. a user interface module for receiving a weapon aiming information in a horizontal plane from a game player;
b. a weapon aiming direction identification module for determining a plurality of aiming directions for the game weapon in the vertical plane based on the received a weapon aiming information;
c. a priority calculation module for calculating a priority value for each of the determined plurality of aiming directions for the game weapon based on location of one or more targets within the game; and
d. a weapon aiming direction selection module for selecting one of the plurality of the determined aiming directions for the game weapon based on the calculated priority values.

2. The gaming client computerized system of claim 1, wherein the determined plurality of aiming directions for the game weapon are weapon aiming directions in a vertical plane.

3. The gaming client computerized system of claim 1, wherein the priority calculation module is configured to assign the priority value based on a distance to a target and wherein the priority value decreases with increase of the distance to the target.

4. The gaming client computerized system of claim 1, wherein the priority calculation module is configured to assign the priority value based on a weapon aiming angle in the vertical plane and wherein the priority value decreases with increase of the weapon aiming angle in the vertical plane.

5. The gaming client computerized system of claim 1, wherein the priority calculation module is configured to assign the priority value based on a game mode, wherein a target with a flag is assigned a higher priority value and wherein a friendly target is assigned a highest priority value.

6. The gaming client computerized system of claim 1, further comprising an additional priority calculation module for calculating an additional priority value for each of the determined plurality of aiming directions for the game weapon based on location of one or more targets within the game, wherein the weapon aiming direction selection module selects one of the plurality of the determined aiming directions for the game weapon based on both the calculated additional priority values and the calculated priority values.

7. The gaming client computerized system of claim 1, wherein the memory further stores a transmission module for transmitting information on the selected one of the plurality of the determined aiming directions for the game weapon to a gaming server computerized system.

8. The gaming client computerized system of claim 7, the gaming server computerized system validates a discharge of the game weapon.

9. The gaming client computerized system of claim 7, wherein the gaming server computerized system transmits information on the selected one of the plurality of the determined aiming directions for the game weapon from the gaming server computerized system to other gaming client computerized systems.

10. The gaming client computerized system of claim 7, wherein the gaming server computerized system transmits information on targets engaged by the game weapon to other gaming client computerized systems.

11. The gaming client computerized system of claim 1, wherein the game weapon is a main gun of a battle tank.

12. The gaming client computerized system of claim 1, wherein the weapon aiming direction identification module determines the plurality of aiming directions for the game weapon within a predetermined angular direction range corresponding to the game weapon between a minimal weapon aiming angle and a maximum weapon aiming angle.

13. The gaming client computerized system of claim 1, wherein the priority calculation module is configured to assign the highest priority to an aiming direction of an un-obscured enemy target and the lowest priority to an aiming direction of a friendly target.

14. The gaming client computerized system of claim 1, wherein the priority calculation module is configured to assign the highest priority to an aiming direction of at least two staggered enemy targets and the lowest priority to an aiming direction of a friendly target.

15. The gaming client computerized system of claim 1, wherein the weapon aiming direction identification module determines the plurality of aiming directions for the game weapon based on deflection of a game weapon projectile by obstacles.

16. The gaming client computerized system of claim 14, wherein the deflection of a game weapon projectile by obstacles is determined based on laws of physics.

17. The gaming client computerized system of claim 1, wherein the game weapon comprises two barrels and wherein the weapon aiming direction identification module determines the plurality of aiming directions separately for each of the two barrels of the game weapon.

18. The gaming client computerized system of claim 1, wherein the priority calculation module is configured to assign the highest priority to an aiming direction of a damaged friendly target and assign a lower priority to an aiming direction of an un-obscured enemy target.

19. The gaming client computerized system of claim 1, wherein the weapon aiming direction identification module determines the plurality of aiming directions for the game weapon within a predetermined angular direction cone corresponding to the game weapon, wherein the aiming directions for the game weapon are limited in the horizontal and vertical plane.

20. The gaming client computerized system of claim 1, wherein the priority calculation module is configured to assign a higher priority value to an aiming direction of an enemy target with a flag.

21. A method for enabling an automatic aiming of a game weapon, the method being performed in connection with a gaming client computerized system comprising a central processing unit, a network interface and a memory, the method comprising:
a. receiving a weapon aiming information in a horizontal plane from a game player;
b. determining a plurality of aiming directions for the game weapon in the vertical plane based on the received a weapon aiming information;
c. calculating a priority value for each of the determined plurality of aiming directions for the game weapon based on location of one or more targets within the game; and
d. selecting one of the plurality of the determined aiming directions for the game weapon based on the calculated priority values.

22. A non-transitory computer-readable medium string a set of instructions, which, when executed in connection with a gaming client computerized system comprising a central processing unit, a network interface and a memory, cause the computerized system to perform a method for enabling an automatic aiming of a game weapon, the method comprising:
a. receiving a weapon aiming information in a horizontal plane from a game player;
b. determining a plurality of aiming directions for the game weapon in the vertical plane based on the received a weapon aiming information;
c. calculating a priority value for each of the determined plurality of aiming directions for the game weapon based on location of one or more targets within the game; and
d. selecting one of the plurality of the determined aiming directions for the game weapon based on the calculated priority values.
